(19) United States
(12) Patent Application Publication
(10) Pub. No.: US 2009/0205579 A1
(43) Pub. Date: Aug. 20, 2009

(54) Pet toy

(75) Inventor: Mark Hirschberg, Tenafly, NJ (US)

Correspondence Address: EPSTEIN DRANGEL BAZERMAN & JAMES, LLP, 60 EAST 42ND STREET, SUITE 820, NEW YORK, NY, 10165, US

(73) Assignee: Multipet International

(21) Appl. No.: 12/070,258

(22) Filed: Feb. 14, 2008

(51) Int. Cl. A01K 29/00

(52) U.S. Cl. 119/707

(57) ABSTRACT

A pet toy is provided including a forward portion simulating the head and front legs of a dog, a rear portion simulating the rear and hind legs of a dog and an elongated, substantially cylindrical body portion connecting the forward portion and the rear portion. The body portion has an exterior plush-like fabric material covering. The toy includes squeeze actuated sound generating means in the form of first and second sound generators. One of the sound generators is situated within the forward portion. The other sound generator is located proximate the rear portion.

### DESCRIPTION OF PRIOR ART INCLUDING INFORMATION DISCLOSED UNDER 37 CFR 1.97 AND 1.98

Although there are many different pet toys in the market, applicant is not aware of any in the shape of a dog with an elongated, flexible body with separate squeeze activated sound generators in the forward and rear portions covered by plus-like fabric material suit able for use both as a back scratcher and a retrieving toy.

### BRIEF SUMMARY OF THE INVENTION

It is, therefore, a prime object of the present invention to provide a dog-shaped pet toy.

It is another object of the present invention to provide a dog-shaped pet toy adapted for use both as a back scratcher and as a retrieving toy.

It is another object of the present invention to provide a dog-shaped pet toy having separate squeeze activated sound generating means.

It is another object of the present invention to provide a dog-shaped pet toy having an elongated body portion covered with a plush-like fabric material.

In accordance with one aspect of the present invention, a pet toy is provided including a forward portion simulating the head and front legs of a dog, a rear portion simulating the rear and hind legs of a dog and an elongated, substantially cylindrical body portion connecting the forward portion and the rear portion. The body portion has an exterior plush-like fabric material covering.

The toy includes squeeze actuated sound generating means in the form of first and second sound generators. One of the sound generators is situated within the forward portion. The other sound generator is located proximate the rear portion.

The sound generator includes a flexible air chamber with an opening. A whistle is situated in the opening. In one embodiment, resilient material is situated within the air chamber.

In one embodiment, the first sound generator generates a sound that is different from that generated by the second sound generator.

In accordance with another aspect of the present invention, a dog-shaped pet toy is provided including a flexible, elongated body. First and second squeeze activated sound generating means are located in spaced relation within the body. The body is covered with plush-like fabric material.

The body has a front portion and a rear portion. The first sound generating means is located in the front portion. The second sound generating means is situated proximate the rear portion.

The body is filled with resilient material.

The toy can be used as a back scratcher or as an object to be thrown and retrieved.

The forward portion of the toy includes hanging means. Preferably, the hanging means takes the form of a loop.

### BRIEF DESCRIPTION OF THE SEVERAL VIEWS OF DRAWINGS

To these and to such other objects that may hereinafter appears, the present invention relates to a dog-shaped pet toy as described in detail in the following specification and recited in the annexed claims, taken together with the accompanying drawings, in which like numerals refer to like parts and in which:

FIG. 1 illustrates the use of the pet toy of the present invention as a back scratcher;

FIG. 2 is an isometric view of the toy of the present invention showing the location of the squeeze activated sound generators and the hanger;

FIG. 3 is an exploded isometric view of the rear portion of the toy showing one embodiment of the sound generator;

FIG. 4 is an isometric view of the forward portion of the toy with a cut-away section showing another embodiment of the sound generator; and

FIG. 5 illustrated the use of the pet toy of the present invention as an object to be retrieved.

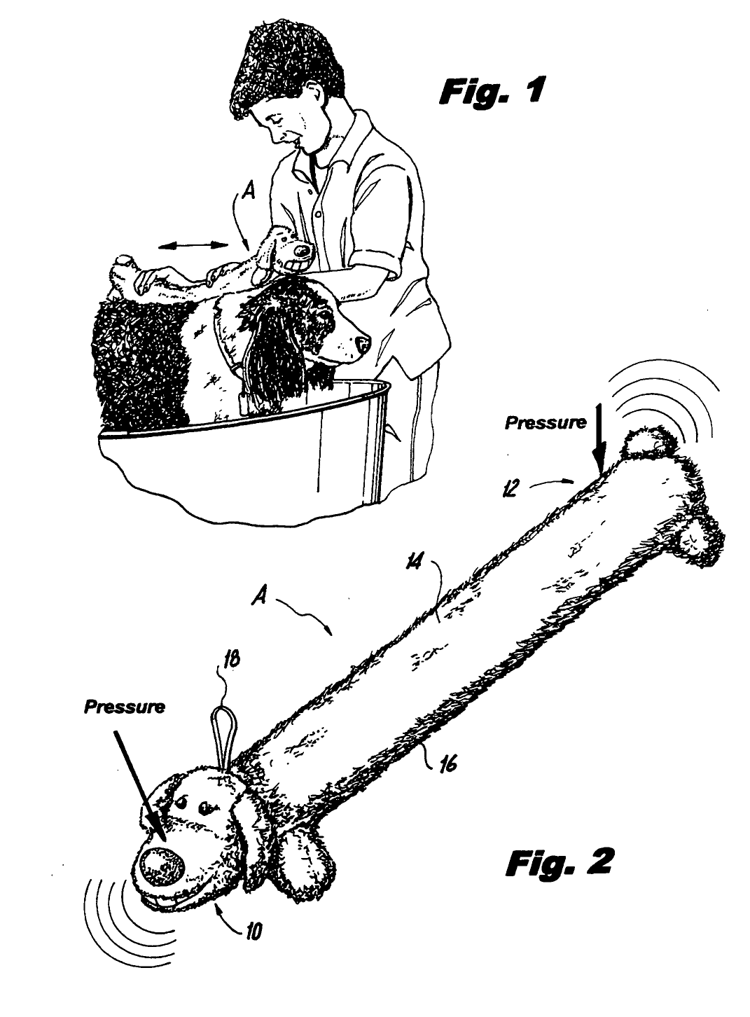

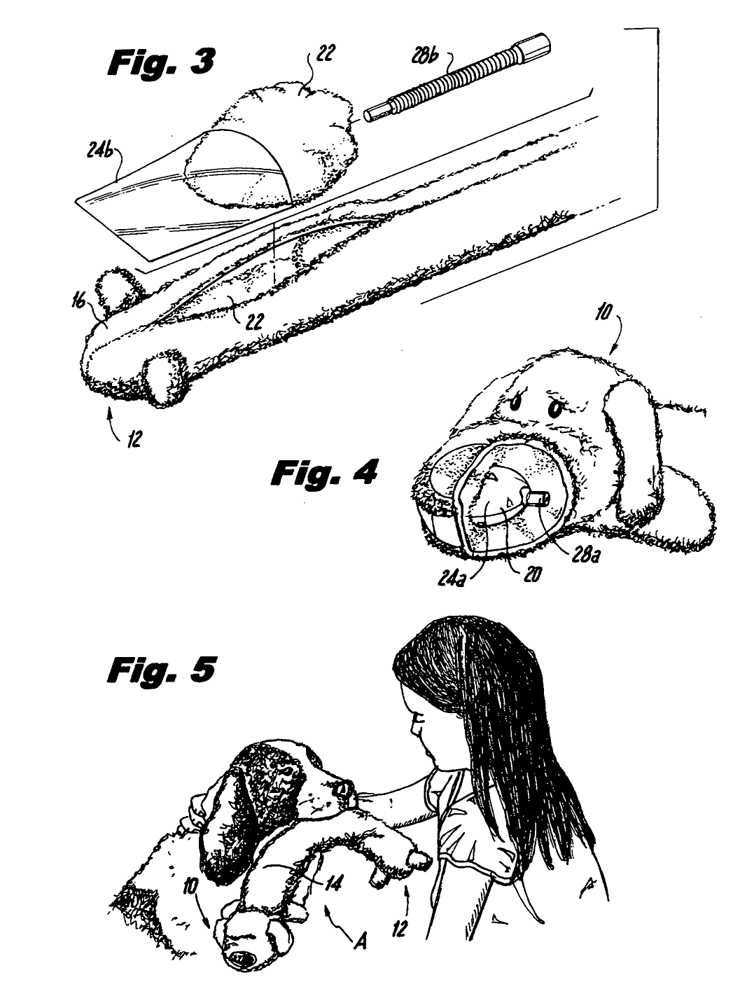

### DETAILED DESCRIPTION OF THE INVENTION

As seen in the drawings, the pet toy of the present invention, generally designated A, includes a forward portion 10 simulating the shape of the head and front legs of a dog, a rear portion 12 simulating the shape of the rear and hind legs of a dog. A flexible, elongated, substantially cylindrical body portion 14 connects forward portion 10 and rear portion 12. Body portion 14 encloses resilient filler material and has an exterior plush-like fabric material covering 16.

A hanger 18 is provided for hanging the toy. Hanger 18 is preferably a loop of material extending from forward portion 10.

The toy incorporates squeeze actuated sound generating means in the form of sound generators 20 and 22. Sound generator 20 is situated within forward portion 10. Sound generator 22 is situated proximate rear portion 12. Sound generators 20 and 22 may make the same or different sounds.

Each sound generator includes a flexible air chamber 24 with an opening 26. A whistle 28 is situated in the opening. However, generator 22 has a molded plastic air chamber 24a that when squeezed and released will return to its original, generally oval shape. It also has a whistle 28a that creates a sound when exiting air passes through it, but not when entering air passes through it. Thus, squeezing chamber 24a causes air to exit the chamber through whistle 28a and a sound is created.

Generator 24 has a bag-like air chamber 24b made of thin, very flexible plastic sheets heat or sonic welded together along the sides and bottom that has insufficient rigidity to return to its original configuration. Accordingly, a wad of resilient material 30 is placed inside chamber 24b such that after the chamber is squeezed causing air to escape through whistle 28b, the wad of material 30 will return to its original shape causing chamber 24b to draw air through whistle 28b and fill chamber 24b. In this generator, the whistle 28b creates sound as air is drawn into the chamber.

It will now be appreciated that the present invention relates to a pet toy including a forward portion simulating the head and front legs of a dog, a rear portion simulating the rear and hind legs of a dog and an elongated. A flexible, elongated substantially cylindrical body portion connects the forward portion and the rear portion. The body portion includes resilient material and has an exterior plush-like fabric material covering.

The toy includes squeeze actuated sound generating means in the form of first and second sound generators. One of the sound generators is situated within the forward portion. The other sound generator is located proximate the rear portion.

While only a limited number of preferred embodiments of the present invention have been disclosed for purposes of illustration, it is obvious that many modifications and variations could be made thereto. It is intended to cover all of those modifications and variations which fall within the scope of the present invention, as defined by the following claims.

I claim:

1. A pet toy comprising a forward portion simulating the head and front legs of a dog, a rear portion simulating the rear and hind legs of a dog and an elongated, substantially cylindrical body portion connecting said forward portion and said rear portion, said body portion having an exterior plush-like fabric material covering.

2. The toy of claim 1 further comprising squeeze actuated sound generating means.

3. The toy of claim 2 wherein said squeeze activated sound generating means is situated within said forward portion.

4. The toy of claim 2 wherein said squeeze activated sound generating means is proximate said rear portion.

5. The toy of claim 2 wherein said sound generating means comprises a flexible air chamber with an opening and a whistle situated in said opening.

6. The toy of claim 5 further comprising resilient material situated within said air chamber.

7. The toy of claim 2 wherein said sound generating means comprises first and second sound generators.

8. The toy of claim 7 wherein said first sound generator generates a sound that is different from said second sound generator.

9. The toy of claim 1 further comprising means for hanging said forward portion.

10. A dog-shaped pet toy, said toy comprising a flexible, elongated body, and first and second squeeze activated sound generating means located in spaced relation within said body, said body being covered with plush-like fabric material.

11. The toy of claim 10 wherein said body comprises a front portion and a rear portion, said first sound generating means being located in said front portion and said second sound generating means being situated proximate said rear portion.

12. The toy of claim 10 wherein said body is filled with resilient material.

13. The toy of claim 10 adapted for use as a back scratcher.

14. The toy of claim 10 adapted for use as a retriever.

15. The toy of claim 11 further comprising means for hanging said forward portion.

16. The toy of claim 15 wherein said hanging means comprises a loop.
